(19) United States
(12) Patent Application Publication
(10) Pub. No.: US 2007/0278990 A1
(43) Pub. Date: Dec. 6, 2007

(54) Battery boosting apparatus and method

(75) Inventors: Kurt Raichle, Owatonna, MN (US); Scott Krampitz, Blooming Prairie, MN (US); Weixing Xia, Portage, MI (US); Dennis A. Robinson, Portage, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/447,204

(22) Filed: Jun. 6, 2006

(51) Int. Cl. H02J 7/00

(52) U.S. Cl. 320/104

(57) ABSTRACT

A method of boosting a vehicle battery includes supplying a current to the battery, detecting an engine crank event, and, upon detecting the engine crank event, dynamically adjusting (i.e., first substantially increasing, and then decreasing) the current in response to battery voltage. The method may also include verifying a crank-ready condition in the battery by comparing one or more of battery voltage, battery current, and battery charge accumulation to respective crank thresholds. In certain embodiments, this verification step occurs only after a minimum charging time has elapsed, and may time out after a maximum charging time. Once the crank ready condition is detected, the operator may be so signaled. At the conclusion of the boost and crank cycle, the current to the battery may be interrupted and the engine status—started or not started—may be detected. The battery may also be monitored for error conditions.

### FIELD OF THE INVENTION

The present invention relates generally to vehicle batteries. More particularly, the present invention relates to a dynamic boost process for a disabled vehicle.

### BACKGROUND OF THE INVENTION

Rechargeable batteries are an important source of clean, portable power in a wide variety of electrical applications, including automobiles, boats, and electric vehicles. Lead-acid batteries are one form of rechargeable battery that is commonly used to start engines, propel electric vehicles, and to act as a source of back-up power when an external supply of electricity is interrupted. While not particularly energy efficient, due to the weight of lead in comparison to other metals, the technology of lead-acid batteries is mature. As a result, the batteries are cheap, reliable, and readily produced, and thus continue to constitute a substantial portion of the rechargeable batteries being produced today.

The ability of lead-acid batteries to deliver large amounts of electrical power is well known, particularly when associated with the starting and powering of motor vehicles. Because lead-acid batteries can be depleted of power over time, such as when they are not in use for an extended period of time or when a light on a car is left on for an extended period of time, they sometimes need to be tested, recharged, and boosted in order to start the vehicle's engine. A number of battery tester, charger, and booster devices, which are sometimes integrated, have thus been developed to test, charge, and boost the lead-acid battery.

Extant battery boost devices typically function in one of two ways, both of which involve the application of a static current to the battery being boosted. Some extant battery boost devices supply an extremely high peaking current. Though it may allow the vehicle to be crank-ready more rapidly, such a high current presents the possibility of permanent damage to or explosion of the battery. In addition, the high current may have undesirable effects on the vehicle's electric system, such as blown fuses. In other traditional battery boost devices, a slightly lower current is applied for a much longer period of time. In such devices, it takes an undesirably long time before the battery is crank-ready. Further, these devices generally require the operator to manually configure the boost current, boost voltage, or both, for example by adjusting transformer taps, thus introducing the possibility of damage due to operator error.

Accordingly, it is desirable to provide a battery boost device that is capable of rapidly bringing a battery to a crank-ready state while substantially reducing the risk of permanently damaging or destroying the battery.

### SUMMARY OF THE INVENTION

The foregoing needs are met, to a great extent, by the present invention, wherein in one aspect an apparatus is provided that in some embodiments rapidly boosts a vehicle battery to a crank-ready state while simultaneously substantially reducing the risk of damaging the battery by dynamically adjusting the current to the battery in relation to a voltage in the battery.

In accordance with one aspect of the present invention, a method of boosting a vehicle battery includes supplying a current to the battery, detecting an engine crank event, and, upon detecting the engine crank event, dynamically adjusting the current in response to a battery voltage. The current is dynamically adjusted in at least two stages. First, the current is increased to a boost amperage. This is followed by stepping the current down from the boost amperage according to a current reduction profile governed by the battery voltage. The method may also include verifying that the battery is in a crank-ready state and signaling the crank-ready state to an operator. The crank-ready state may be determined based on one or more of battery voltage, battery current, and battery charge accumulation. In some embodiments, the crank-ready state is only detected during a time interval between a minimum charging time and a maximum charging time. Once the current has been stepped down, it may be halted, and the engine status—started or not started—may be determined and signaled. If the engine has not started, the process may repeat. The process may also periodically or continually monitor for battery error conditions, such as shorts or faulty connections.

In accordance with another embodiment of the present invention, a vehicle battery boosting system is disclosed. The system includes a current source supplying an output current to the vehicle battery and a current source management module. The current source management module dynamically adjusts the output current of the current source during a boost cycle according to a current profile governed by a battery voltage profile. The system may include a battery monitoring module that monitors one or more of battery voltage, battery current, battery charge accumulation, and battery error conditions. The system may also include a notification device configured to notify an operator of, for example, a crank-ready condition in the battery.

In accordance with yet another embodiment of the present invention, a vehicle battery boosting system includes means for supplying a current to a vehicle battery, means for monitoring a voltage in the battery during a boost cycle, and means for dynamically adjusting the current during the boost cycle. The adjusting means is responsive to the voltage in the battery.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a hardware block diagram of an embodiment of the current invention.

FIG. 2 is a hardware block diagram of a battery tester/charger.

FIG. 3 is a flowchart illustrating steps that may be followed in performing a boost cycle according to an embodiment the present invention.

FIG. 4 is a graph illustrating exemplary battery voltage and boost current profiles during a boost cycle according to an embodiment of the present invention.

FIG. 5 is a flowchart illustrating, in further detail, certain aspects of the error checking step shown in FIG. 3.

### DETAILED DESCRIPTION

The invention will now be described with reference to the drawings, wherein like reference numerals refer to like parts throughout. An embodiment in accordance with the present invention provides a method of boosting a vehicle battery by supplying a current to the battery, detecting an engine crank event, and, upon detecting the engine crank event, dynamically adjusting (i.e., first substantially increasing, and then decreasing) the current in response to battery voltage.

The method may also include verifying a crank-ready condition in the battery by comparing one or more of battery voltage, battery current, and battery charge accumulation to respective crank thresholds. In certain embodiments, this verification step occurs only after a minimum charging time has elapsed, ensuring that the battery has at least a minimum level of charge before cranking. Similarly, the verification process may time out after a maximum charging time, after which the operator may conclude that the battery is not efficiently or economically boostable and should be replaced rather than recharged and boosted. Once the crank ready condition is detected, the operator may be so signaled.

By supplying a baseline current to the battery, the present invention rapidly brings a battery to a crank-ready state (or, alternatively, rapidly determines that the battery will not achieve a crank-ready state and should be replaced). Further, by dynamically adjusting current to the battery in response to battery voltage, the present invention substantially reduces the risk of damage to or destruction of the battery during the boosting and cranking process.

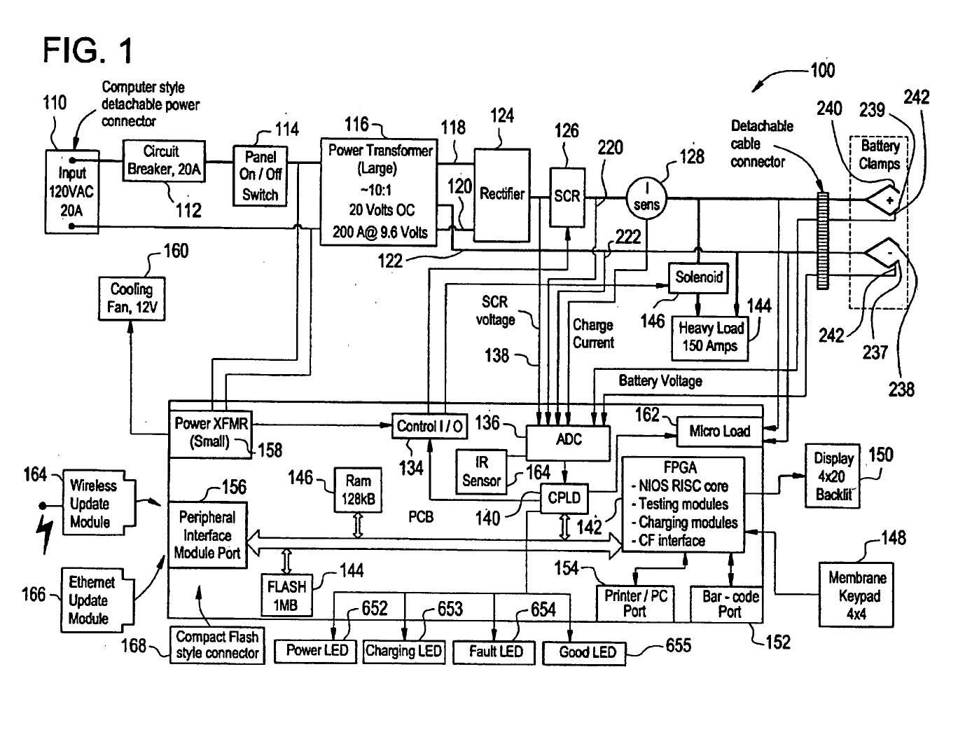

An embodiment of the present inventive apparatus is illustrated in FIG. 1. A battery charger/tester 100 (also referred to herein as charger 100) can include a power source 110 that provides a 120 volt alternating current to charger 100. A circuit breaker 112 is provided to prevent damage that can be caused by a sudden power surge or a short in the system. A power switch 114 is linked to the power source 110 to enable an operator to turn charger 100 on or off.

A power transformer 116 is provided to step down both the voltage and current to a level that enables the charger 100 to charge and/or test a battery. In some embodiments, the power source 110 supplies the charger 100 with 120V AC. The power transformer 116 reduces the 120V AC to approximately 20-25V AC, which is optimal for charging the battery. Two lines 118, 120 from the power transformer 116 are inputted into a rectifier 124, while a third line 122 is directly coupled to a negative battery clamp 238. The lines 118, 120 pulse alternately through a full-wave rectifier 124 at a 60 Hz cycle. The diodes of the rectifier 124 convert the positive AC voltage to DC power supply. The third line 122 provides a return path for the negative voltage of outputs 118, 120 to return to the transformer 116.

A silicon control rectifier (“SCR”) 126 or thyristor is included in some embodiments to regulate the output from the rectifier 124 to the battery. A pulsed positive sine waveform with peak voltages and current exits from the rectifier 124. The sine waveform results in varying voltages and current being outputted from the rectifier 124. The SCR 126 operates as a switch allowing certain voltages and/or currents to pass to the battery.

The operator can choose a voltage, a current, or both to charge the battery. This selection is called a set-point. The set-point is transmitted to a field programmable gate array (“FPGA”) 142, discussed below, which then determines at which point in the sine wave to allow voltage to pass through to the battery. This point in the sine wave is related to the set-point as chosen by the operator. The set-point, depending on the selection of the operator, is situated on the sine wave by starting from the end of the sine wave and working in a rearward direction. Once the set-point is located on the sine wave, the voltage underneath the sine wave is allowed to pass through. Therefore, the set-point voltage is a mean value of a range of voltages.

For example, if the operator decides to charge the battery at 12V, this set-point of 12V is entered into the charger 100. The set-point is transmitted to the FPGA 142, which then determines at which point in the sine wave to allow the voltage or current to pass through to the battery. The 12V set-point in this example permits voltages larger than and less than 12V to pass through to the battery. The mean of the voltages distributed to the battery will approximately equal twelve volts.

SCR 126 is normally switched off until it receives a signal from an I/O control (input/output) 134. The voltage or current exiting from the rectifier 124 is transmitted to an analog-to-digital converter (“ADC”) 136. The ADC 136 in turn transmits the voltage or current information to a linked computer programmable logic device (“CPLD”) 140, which is linked to the FPGA 142. The FPGA 142, simulating a processor, determines the operability of the SCR 126 by comparing the previously programmed set-point value with the output value of the rectifier 124. If the output value of the rectifier 124 is equal or greater than the set-point of the SCR 126, then the FPGA 142 instructs the input/output (“I/O”) control 134 to send a signal to the SCR 126 to allow the output voltage or current to pass to the battery. For example, if the operator desires a minimum current of 20 amps, the SCR 126 will allow a current equal to or exceeding 20 amps to pass to the battery.

A current sensor 128 is provided at the output of the SCR 126 to monitor or sense the current exiting from the rectifier 124 and the SCR 126. The current from the rectifier 124 is relayed to the ADC 136, which like the voltage is fed to the CPLD 140 and then onto the FPGA 142. The FPGA 142 verifies if the current from the rectifier 124 is equal to or exceeds the current set-point value. The output from the current sensor 128 is connected to the battery clamps 238, 240.

In some embodiments of the present invention, a conventional processor is replaced by a dynamic FPGA 142. The use of the FPGA 142 allows a designer to make changes to the charger 100 without having to replace the processor. Changes to a mounted conventional processor requires remounting and reconfiguration of the charger 100 design, which in turn requires more design hours. With the use of the FPGA 142, the designer is allowed to make changes and additional costs on the fly without remounting or tiresome reconfiguration of the initial design.

The FPGA 142 is configured and arranged to operate as a conventional processor. In some embodiments of the invention, the FPGA 142 controls and processes a number of different functions of the charger 100, such as the intelligent boost function described herein. These functions are downloaded and stored into a memory device 144. It can also be stored in a RAM device 146. Once stored in these memory devices 144, 146, the code is downloaded into the FPGA 142 and executed. Upon execution of the code, the FPGA 142 begins to operate various controls of the charger 100, such as the SCR 126 for current and voltage control. Additionally, data can be inputted into the FPGA 142 through the input device 148, such as a keypad. The FPGA 142 can transmit to and receive information from an output display 150, a serial port 154, such as a printer port, a second serial port 152, such as an infrared bar code reader, a module port 156 that can accept various communication modules, or any other device that can communicate with the FPGA.

Upon start-up or boot-up of the charger 100, an image of a soft-core microprocessor is loaded from the memory (i.e. flash 144, RAM 146, etc.) into the FPGA 142. Therefore, there is an image of the FPGA 142 resident in the memory. Additionally, upon start-up, the CPLD 140 takes control of the data and address bus and clocks the FPGA 142 image from memory into the FPGA 142. As stated previously, this allows for redesign of the processor and the board without the need for remounting a processor. All that is necessary for a design change is to upload a new FPGA image into the memory device. Additionally, any new tests or operating parameters required by the operator can be easily upload into the FPGA 142 and executed. The preferred embodiment uses flash memory 144 to accomplish this function.

The output display 150 can be an integrated display or a remote display that relays information, such as data gathered from the charging and testing of the battery, and menu information. Additionally, the display 150 can notify the operator of any problems that have been detected. The serial port 154 may be a standard RS-232serial port for connecting a device such as a printer. One of ordinary skill in the art will recognize that the RS-232can be replaced with an RS-432, an infrared serial port or a wireless radio frequency port, such as BLUETOOTH™, or any other similar device.

In some embodiments of the current invention, a bar code port 152 is provided. The bar code port 152 may serve to operably connect a bar code reader (not shown) to the FPGA 142 or a microprocessor. In some embodiments, the bar code port 152 may be a conventional component, such as an RS-232. The bar code reader may be, for example, a conventional optical bar code reader, such as a gun or a wand type reader.

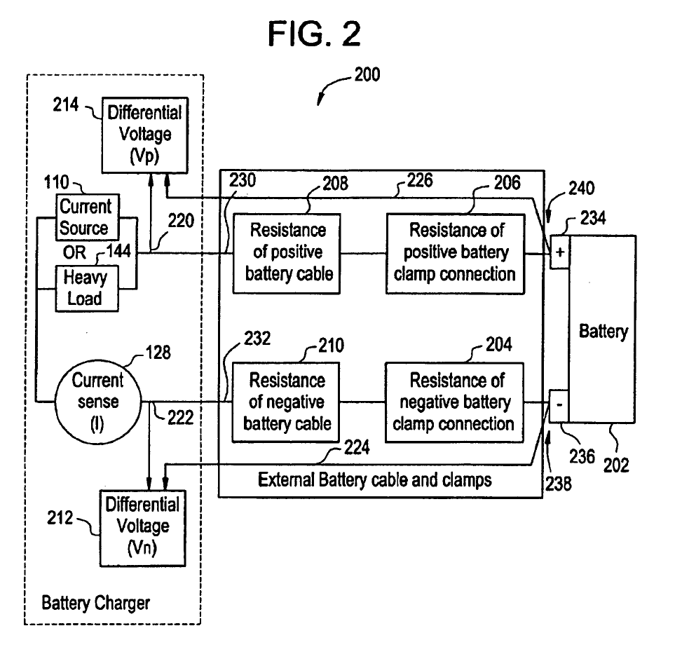

FIG. 2 illustrates a battery tester/charger 200 according to an embodiment of the present invention. A battery 202 having a positive terminal 234 and a negative terminal 236 may be attached to the battery tester/charger 200 via a positive clamp 240 and a negative clamp 238 located at respective ends of positive and negative cables 230, 232. Standard clamps 238, 240, such as alligator clamps, may be used.

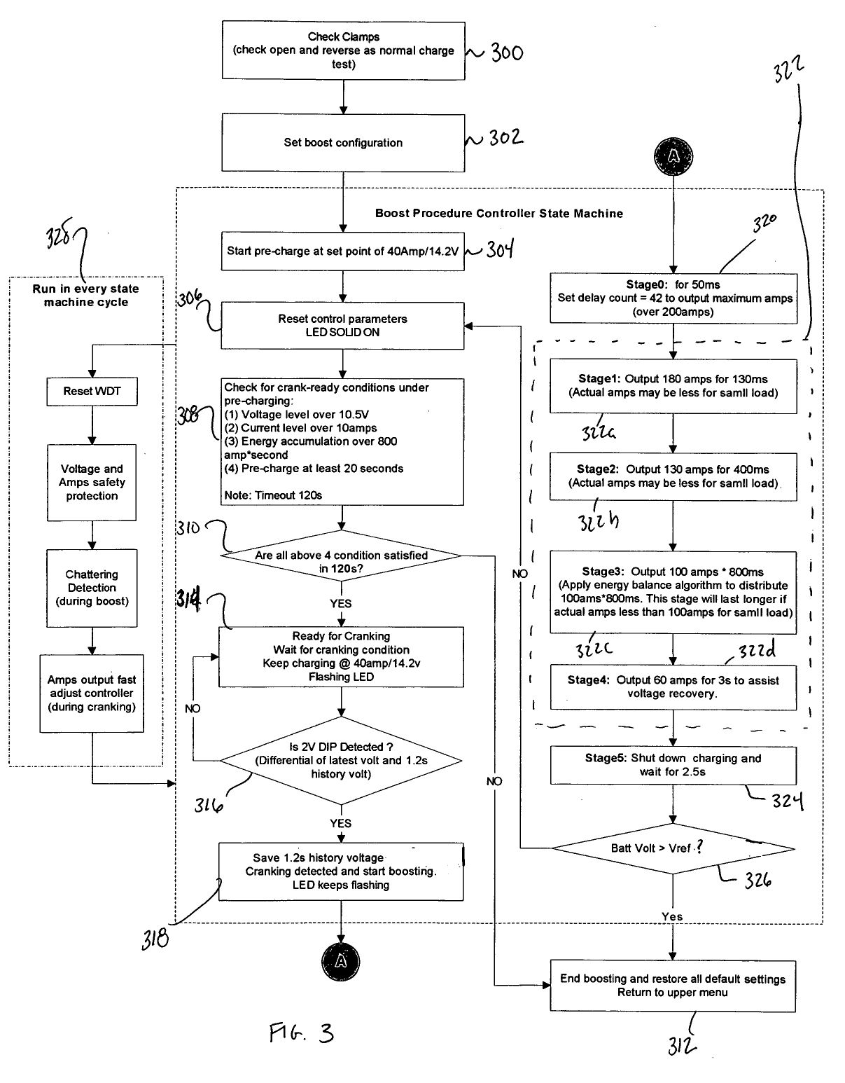

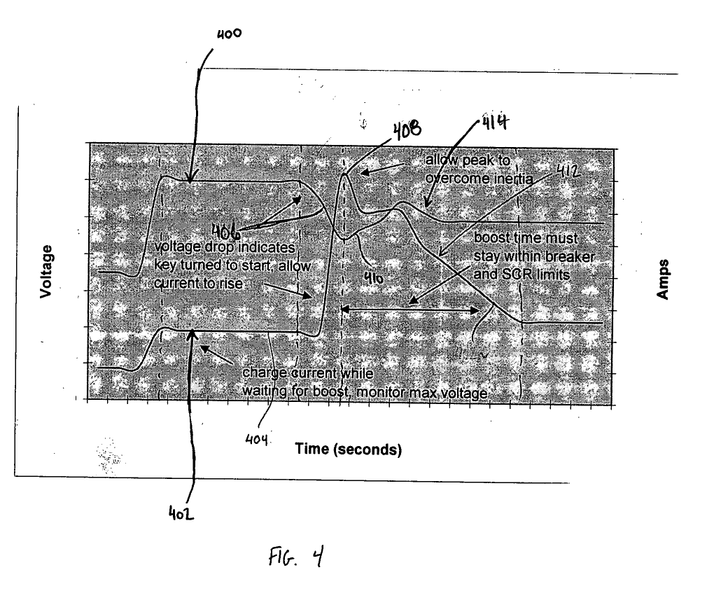

Battery tester charger 200 includes an intelligent boost function, controlled by a current source management module and, in certain embodiments, a battery monitoring module, to assist in starting the engine of a disabled vehicle. The intelligent boost function will be described with reference to the flowchart of FIG. 3 and the exemplary battery voltage and boost current profiles 400 and 402, respectively, of FIG. 4. It should be understood that battery voltage profile 400 represents the voltage detected in battery 202 by battery tester charger 200, while boost current profile 402 represents the current supplied by battery tester charger 200 to battery 202. As described herein, however, the two are interrelated.

Referring now to FIG. 3, in step 300, battery tester charger 200 is connected to a battery 202, for example via clamps 238, 240 as described above, and the clamps are checked for proper connections, as discussed below. In step 302, the operator configures battery tester charger 200 for the boost operation by selecting the boost function from a menu, which may be on a display, for example via the input device 148. No further user configuration is required, thereby reducing the potential dangers associated with operator error.

Battery tester charger 200 then begins to supply battery 202 with a relatively constant pre-charge current in step 304. In certain embodiments of the invention, for example as illustrated in FIG. 4, the pre-charge current 404 associated with step 304 is approximately 40 amps, though other amperages for pre-charge current 404 may be used without departing from the scope of the invention. While performing pre-charging step 304, battery tester charger 200 may provide a signal to the operator that pre-charging is occurring in step 306. This signal may be an optical signal, such as a solidly-illuminated light emitting diode (LED), an audible signal, a textual prompt on display 150, or some combination thereof. Step 306 further resets the control parameters of battery tester charger 200. Resetting the control parameters effectively clears battery tester charger 200 of any memory regarding battery voltage, battery current, and battery charge accumulation in preparation for subsequent steps.

In step 308, battery tester charger 200 monitors battery 202 for a crank-ready condition. Monitoring of battery voltage, battery current, and/or battery charge accumulation may be accomplished, for example, via a battery monitoring software module loaded into battery tester charger 200 (i.e., loaded into FPGA 142 from memory 144, 146). In some embodiments of the invention, a crank-ready condition exists when the battery voltage exceeds a crank voltage threshold, the battery current exceeds a crank current threshold, and the battery charge accumulation exceeds a crank charge accumulation threshold. One skilled in the art will recognize that any or all of these factors may be used, either singly or in combination, to verify a crank-ready condition in the battery 202. By way of example only, the crank voltage threshold may be about 10.5 volts, the crank current threshold may be about 10 amps, and the crank charge accumulation threshold may be about 800 coulombs. That is, in this example, a crank-ready condition will not exist until the battery voltage exceeds 10.5 volts, the battery current exceeds 10 amps, and the battery charge accumulation exceeds 800 coulombs. It should be understood, however, that other thresholds may be set without departing from the spirit and scope of the present invention.

In some embodiments of the invention, battery tester charger 200 will not proceed to monitoring step 308 until a minimum charging time, (that is, a minimum duration of pre-charging step 304, such as about 20 seconds) has elapsed. This waiting period helps to ensure at least a minimum level of charge accumulation in battery 202, such that the operator does not attempt to crank a completely discharged battery 202, which could have undesirable consequences, including, but not limited to, permanently damaging or destroying the battery 202. It should be understood that, since charge accumulation within battery 202 is a function of both the pre-charge current and the duration of the pre-charge step 304, an increase in one may be accompanied by a decrease in the other and vice versa. That is, a shorter minimum charging time coupled with a higher pre-charge current is regarded as within the scope of the present invention, as is a longer minimum charging time coupled with a lower pre-charge current.

Similarly, monitoring step 308 may time out after a maximum charging time, such as 120 seconds, as shown in step 310. If the crank-ready condition is not verified within the window of the maximum charging time, boosting will cease in step 312. The operator may then properly conclude that it would be more economical to replace the battery 202 than to continue to attempt to boost it. One skilled in the art will recognize that the maximum charging time may be adjusted upwards or downwards without departing from the spirit and scope of the present invention.

If the crank-ready condition is verified in step 310, the operator may be so notified in step 314. For example, the LED may begin to flash or a tone may sound to alert the operator to crank the engine. While awaiting the crank event, battery tester charger 200 continues to pre-charge battery 202. Since pre-charging occurs at a relatively low current that is unlikely to adversely affect the vehicle's electrical system, it is not imperative to immediately crank the engine upon receiving notification.

Once the crank-ready condition has been verified and the operator so notified, battery tester charger 200 monitors the voltage of the battery 202 in order to detect an engine crank event in step 316. As shown in FIG. 4, a crank event (that is, turning the vehicle ignition key to the start position) is indicated by a dip 406 in the battery voltage profile 400 of approximately two volts. Thus, battery tester charger 200 monitors for a two volt dip in battery voltage, such as by periodically sensing battery voltage and comparing the instantaneous reading to the immediately previous reading. If a two volt dip is not detected by this comparison, the process returns to step 314.

Once battery tester charger 200 detects the voltage drop corresponding to a crank event, it begins to dynamically adjust the current to the battery 202 in response to the battery voltage. Dynamic adjustment may be accomplished, for example, via a current source management software module loaded into battery tester charger 200 (i.e., loaded in FPGA 142 from memory 144, 146). The battery voltage at the time of the crank event is stored in step 318 for subsequent use in determining whether the engine has started or not. A signal may also be provided to the operator to indicate that boost cycle is (i.e., dynamic current adjustment) is occurring; in certain embodiments, this signal is a flashing LED.

Dynamic current adjustment occurs in at least two phases: a peaking phase in step 320 and a recovery phase in step 322. Initially, battery tester charger 200 rapidly increases the current from the pre-charge amperage 404 to boost amperage 408, which may be over about 200 amps, in step 320. The boost amperage 408 provided in step 320, though helpful in overcoming the inertia of the dip in voltage profile 400 caused by cranking the engine, is potentially high enough to adversely affect the vehicle's electrical system, for example by blowing fuses or tripping circuit breakers. Thus, once the battery voltage profile 400 begins to recover, as shown in FIG. 4 by profile segment 410, battery tester charger 200 begins to reduce or step-down the current in step 322. Reduction is performed according to a current reduction profile 412, which is governed by the battery voltage 414. It is contemplated that, by dynamically managing the boost current profile 402 in response to battery voltage, the battery voltage profile 400 will be maintained at a level sufficiently high to start the engine without any adverse effects on the vehicle's electric system associated with extremely high currents over long periods of time.

In some embodiments, dynamic current reduction step 322 is a multi-stage process including: supplying about 180 amps for about 130 milliseconds in step 322a, supplying about 130 amps for about 400 milliseconds in step 322b, supplying about 100 amps for about 800 milliseconds in step 322c, and supplying about 60 amps for about 3 seconds in step 322d. One skilled in the art will recognize, however, that the duration and amperage in any particular stage of dynamic current reduction step 322 may vary without departing from the spirit and scope of the present invention. Similarly, it is contemplated that additional or fewer stages may comprise dynamic current reduction step 322. In short, dynamic current reduction step 322 is constrained by the input power supply (i.e., the maximum capacity of the power line), circuit breaker, and SCR limits, and, as discussed above, is governed by the battery voltage 414.

Once the current has been reduced in step 322, battery tester charger 200 halts the flow of current to battery 202 in step 324. A waiting period, such as 2.5 seconds, then ensues to permit vehicle systems to stabilize. At the conclusion of the waiting period, in step 326, battery tester charger 200 detects whether the engine has started or not. The engine status is determined by comparing a measured battery voltage to a reference voltage, where the reference voltage is derived from the voltage stored in step 318 by subtracting about one volt therefrom. If the measured battery voltage exceeds the reference voltage, battery tester charger 200 concludes that the engine has started, and the boost process will stop in step 312. The operator may then be notified that the boost cycle has completed successfully, for example by turning off the LED indicator or sounding a tone.

If, however, the measured battery voltage does not exceed the reference voltage, battery tester charger 200 concludes that the engine has not started. In this case, the process repeats from step 306 (that is, battery tester charger 200 returns to the pre-charge process and once again awaits a crank-ready condition).

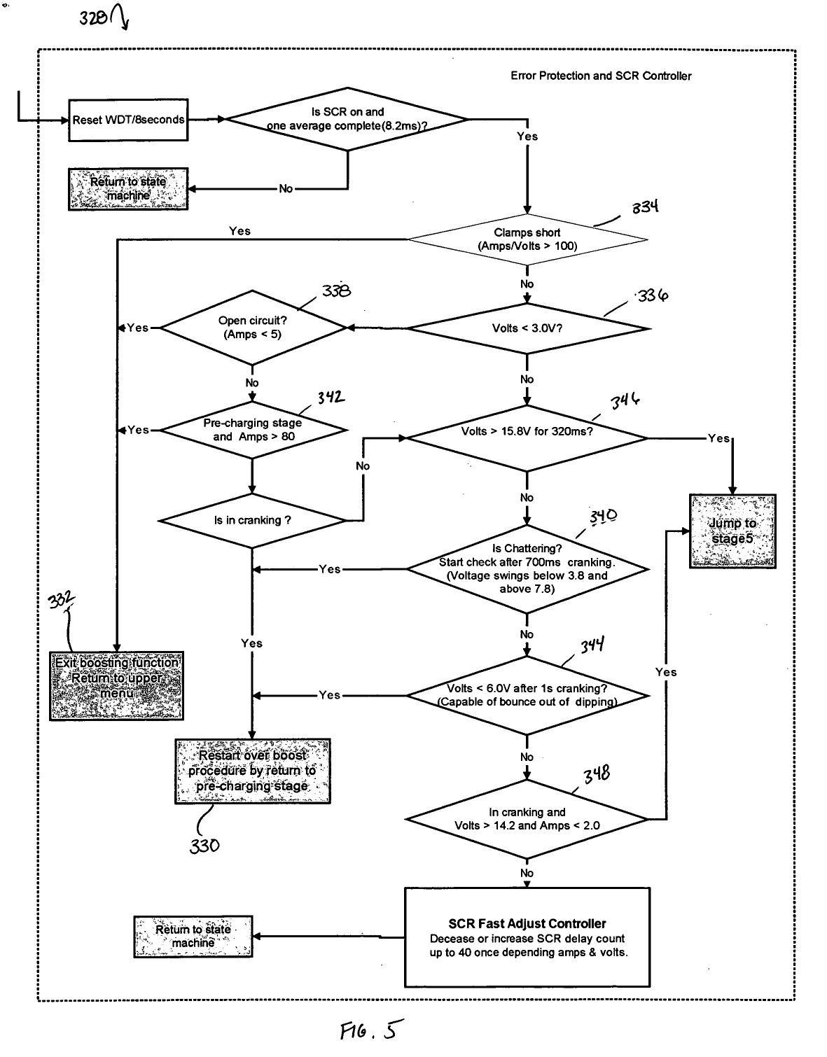

An error monitoring step 328, further illustrated in FIG. 5, occurs in parallel with steps 300-326. That is, battery tester charger 200 may periodically or continuously monitor battery 202 for error conditions, including, but not limited to, clamp shorts, open circuits, reversed connections, sulfating, freezing, chattering, and any combination thereof. When an error condition is detected, appropriate corrective action can be taken. For certain errors, referred to herein as recoverable errors, the error can be corrected simply by restarting the boost process (step 330). Other errors, referred to herein as non-recoverable errors, will halt the process so that the operator can take corrective action (step 332). Once the condition has been addressed, the operator can restart the boost process.

For example, in some embodiments of the invention, the battery tester/charger 200 can determine whether the connections between the battery 202 and the clamps 238, 240 are acceptable in step 334. A connection test may be performed at either the positive 240 or the negative clamp 238 connection by applying the connection test to the positive components 230, 240 or negative components 232, 238 of the battery tester charger 200. The connection test may equally be applied to both components. The connection test may be performed by comparing the voltage in the battery cables 230, 232 upstream from the connection of the clamps 238, 240, and the voltage at the connection of the clamps 238, 240. Voltage loss due to cable resistances 208, 210 may be considered and subtracted from the difference in voltage at the clamps 238, 240 and the upstream position. Additional differences in voltage between the upstream position and the connections of the clamps 238, 240 may be caused by clamp connection resistances 206, 204.

A portion 237, 239 (FIG. 1) of each clamp 238, 240 is isolated from the remainder of the clamps 238, 240 and the associated cables 232, 230. Portions 237, 239 can be isolated from the remainder of the clamps 238, 240 by a non-conductive element. The cables 232, 230 can carry a large current, either to the battery 202 when charging or from the battery when the battery is in use. The isolated portions 237, 239 may be connected to another device to determine the voltage at terminals 234, 236. For example, the isolated portions 237, 239 may be attached to high impedance wires 226, 224 to differential operational amplifiers 214, 212 (opp. amp) as shown in FIG. 2. Alternately, in some optional embodiments, as shown in FIG. 1, the high impedance wires 226, 224 may be attached to the ADC 136.

The battery connections may be tested to determine the resistances 206, 204 associated with the connection when the battery 202 is charged by a current source 110 or exposed to a heavy load 144. Whether the battery 202 is charging or in use, large current will flow through the cables 230, 232 and clamps 240, 238. A sensor 220, 222 in the battery charger tester 200 senses the voltage upstream from the clamps 240, 238 and the battery terminals 234, 236 connections and inputs a signal representative of the voltage to opp amps 214, 212 or optionally to the ADC 136. For example, in some optional embodiments of the invention, the voltage may be sensed upstream from the current sense 128 in both cables 230, 232 as shown in FIG. 1. As mentioned above, voltage is sensed in the isolated portions 237, 239 and compared to the voltage sensed upstream. The cable resistances 208, 210 are known, and the portion of the voltage difference between the voltage in the isolated portions 237, 239 and the voltage at the upstream position is accounted for by the cable resistances 208, 210. The remaining voltage difference between the voltage measured at the isolated portions 237, 239 and the upstream positions is due to the resistances in the clamps 240, 238 and terminal connections 234, 236. In optional embodiments of the invention, cable resistances 208, 210 and the associated difference in voltage due to cable resistances 208, 210, may be neglected or approximated.

The resistance of the connections 206, 204 can be analyzed using Ohm's law, V=I·R, where V stands for voltage, I stands for current, and R stands for resistance. Simple algebraic manipulation yields R=V/I. The unknown connection resistances 206, 204 associated with the connection can be expressed in terms of known parameters of current and voltage, thus the resistances 206, 204 can be determined.

Once the connection resistances 206, 204 are determined, each connection can be evaluated to determine whether the connection is acceptable or not. In one embodiment, a method is provided and compares the connection resistances 206, 204 against a predetermined acceptable and non-acceptable range of connection resistance. Based on the comparison, the operator can determine whether the connection is acceptable or not.

In an alternative embodiment, a method is provided to compare the voltage differences between the isolated portions 237, 239 and the voltage in the cables 230, 232 at the upstream positions. If the difference in voltage between the two locations is negligible, then the connection is likely to be acceptable. Optionally, the difference in voltage due to cable resistances 208, 210 may be subtracted from the voltage difference or otherwise accounted for in determining whether the connections are acceptable or not. If the voltage difference is higher than a predetermined maximum amount, then the connection between the battery terminal 234 and the clamp 140 will likely be unacceptable.

If the connection is not acceptable, the battery tester charger 200 can alert or notify the operator in step 332, wherein the battery tester charger 200 also may stop the boost process. In some embodiments, the battery tester charger 200 may alert the operator as to which connection (positive or negative) is unacceptable or whether both are unacceptable. In some embodiments, the battery tester charger 200 may alert the operator that the connection(s) are acceptable. The operator may be alerted by a variety of ways, such as an indicator light, a message on a display screen, an audible signal, or other ways that are disclosed herein. Because the operator is warned that a connection is not acceptable, the operator may take corrective measures to improve the connection, such as cleaning or replacing the terminals 234, 236 or clamps 240, 238.

Referring to FIG. 1, in some embodiments of the invention, a heavy load test is used to analyze the condition of the battery. The heavy load test is applied with a heavy load 144 that includes a solenoid switch 146. The solenoid switch 146 is operated by the FPGA 142 through the I/O control 134 via the CPLD 140. The solenoid switch 146 in the heavy load test ensures that a high load amperage test can be efficiently and safely transmitted to the battery. One of ordinary skill in the art will recognize that the solenoid 146 can be replaced with electronic switching devices such as transistors in alternate embodiments.

Heavy load tests are highly accurate for testing charged batteries. If the battery to be tested is partially charged, then the test accurately determines whether the battery is defective. A person skilled in the art will recognize that any heavy load test procedure that is suitable for testing the condition of the battery may be used. Additionally, load as used herein can also be a charge.

Some embodiments of the present invention also include an infrared temperature sensor 164, which aids in monitoring both the charger 100 and the battery being charged. The infrared temperature sensor 164 ensures that both the battery and charger 100 are maintained at safe temperature levels. The infrared sensor 164 may be contained within a housing. The housing is placed over the charging battery for safety reasons especially in the instance that, while charging, the battery unexpectedly explodes. The housing aids in containing the surrounding areas from the contaminants of the exploded battery.

The infrared temperature sensor 164 is placed within the housing to monitor the temperature of a charging battery. While charging a battery, heat is discharged or dissipated from the battery. However, excessive heat is an indication that the battery is being charged at an excessive rate. In some embodiments, the infrared temperature sensor 164 is linked to the ADC 136, essentially an input to the ADC 136, which relays the information to the CPLD 140, which then relays it to the FPGA 142. The FPGA 142, with the help of the infrared temperature sensor 164, can monitor the temperature of the battery and relay the information, including any problems, to the operator. The infrared temperature sensor 164 is aimed at the battery to ensure that the temperature of the battery is being monitored throughout the charging process. For example, if the battery being charged contains a short, the battery will heat excessively in a short period of time. The feedback from the infrared temperature sensor 164 can be used to alert the operator of the problem so that the operator can take the appropriate action.

In other embodiments, the infrared temperature sensor 164 can be aimed at the charger 100 only or in combination with the battery. By monitoring the charger 100, any excessive temperature generated by the charger can be relayed to the operator, thus appropriate actions can be taken to avoid overheating and damaging the charger. One of ordinary skill in the art will further recognize that the temperature sensor 164 can be located in a number of different locations in the charger 100 or linked to the charger 100. The location of the infrared temperature sensor 164 is not limited to a housing. Additionally, temperature sensors are needed most when the battery is charging. Therefore, monitoring the temperature of the battery and/or the charger can help to prevent battery explosions.

As further illustrated in FIG. 5, error monitoring step 328 may also monitor for additional error conditions, including, but not limited to, a low voltage condition (step 336), an open circuit condition (step 338), a chattering condition (step 340), a high pre-charging current condition (step 342), and a low cranking voltage condition (that is, where the battery voltage has not recovered after a certain amount of time of cranking) (step 344). In addition, error monitoring step 328 may act as a controller for SCR 126 by detecting conditions (steps 346 and 348) that may move the boost process from dynamic current reduction step 322 to waiting period step 324.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of boosting a vehicle battery to assist in starting a vehicle engine, the method comprising:
supplying a current to the battery;
detecting an engine crank event; and
upon detecting the engine crank event, dynamically adjusting the current in response to one or more of a measured battery voltage and an input power limitation.

2. The method according to claim 1, wherein dynamically adjusting the current in response to a battery voltage comprises:
increasing the current to a boost amperage upon detecting a lowered battery voltage corresponding to the crank event; and
stepping the current down from the boost amperage according to a current reduction profile governed by one or more of the battery voltage and the input power limitation.

3. The method according to claim 1, further comprising verifying a crank-ready condition in the battery at a time occurring between a minimum charging time and a maximum charging time.

4. The method according to claim 3, further comprising signaling the crank-ready condition.

5. The method according to claim 3, wherein verifying a crank-ready condition in the battery comprises at least one step selected from the group consisting of:
detecting a battery voltage exceeding a crank voltage threshold;
detecting a battery current exceeding a crank current threshold;
detecting a battery charge accumulation exceeding a crank charge accumulation threshold; and
any combination thereof.

6. The method according to claim 5, wherein the battery voltage threshold is about 10.5 volts.

7. The method according to claim 5, wherein the battery current threshold is about 10 amperes.

8. The method according to claim 5, wherein the battery charge accumulation threshold is about 800 Coulombs.

9. The method according to claim 3, wherein the minimum charging time is about 20 seconds and the maximum charging time is about 120 seconds.

10. The method according to claim 1, further comprising:
halting the current;
detecting an engine status, the engine status being either a start status or a no start status; and
signaling the engine status.

11. The method according to claim 10, further comprising, upon detecting the no start status, repeating the steps of:
supplying a current to the battery;
detecting an engine crank event; and
upon detecting the engine crank event, dynamically adjusting the current in response to one or more of the battery voltage and the input power limitation.

12. The method according to claim 10, wherein detecting the engine status comprises comparing a measured battery voltage to a reference voltage, wherein a measured battery voltage in excess of the reference voltage indicates the start status and wherein a measured battery voltage below the reference voltage indicates the no start status.

13. The method according to claim 1, further comprising:
monitoring the battery for an error condition; and
executing a corrective operation upon detecting the error condition.

14. The method according to claim 13, wherein monitoring the battery for an error condition comprises monitoring the battery for an error condition selected from the group consisting of: a clamp short, an open circuit, a reversed connection, a sulfated battery, a frozen battery, a chattering battery, and any combination thereof.

15. The method according to claim 13, wherein executing a corrective operation upon detecting the error condition comprises:
detecting either a recoverable error condition or a non-recoverable error condition;
upon detecting the recoverable error condition, repeating the steps of:
supplying a current to the battery;
detecting an engine crank event; and
upon detecting the engine crank event, dynamically adjusting the current in response to one or more of a battery voltage and an input power limitation; and
upon detecting the non-recoverable error condition, halting the current.

16. A vehicle battery boosting system, comprising:
a current source supplying an output current to a battery; and
a current source management module,
wherein said current source management module dynamically adjusts the output current of the current source during a boost cycle according to a current profile governed by one or more of a battery voltage profile and an input power limitation.

17. The system according to claim 16, further comprising a battery monitoring module, wherein said battery monitoring module measures at least one factor selected from the group consisting of: battery voltage, battery current, battery charge accumulation, battery error conditions, and any combination thereof.

18. The system according to claim 16, wherein said current source management module automatically halts the output current upon detecting either a non-recoverable error condition in the battery or an engine start condition.

19. The system according to claim 16, further comprising a notification device.

20. A vehicle battery boosting system, comprising:
means for supplying a current to a vehicle battery;
means for monitoring a voltage in the battery during a boost cycle; and
means for dynamically adjusting the current during the boost cycle, said adjusting means being responsive to one or more of the voltage in the battery and limitations on the current supplying means.
